(19) United States
(12) Patent Application Publication
(10) Pub. No.: US 2004/0253973 A1
(43) Pub. Date: Dec. 16, 2004

(54) Method and apparatus for providing efficient text entry using a keypad

(76) Inventors: Manh T. Nguyen, Palatine, IL (US); Bruce Edward Geren, Chandler, AZ (US)

Correspondence Address: MOTOROLA, INC., 1303 EAST ALGONQUIN ROAD, IL01/3RD, SCHAUMBURG, IL, 60196

(21) Appl. No.: 10/460,490

(22) Filed: Jun. 12, 2003

(51) Int. Cl. H04B 1/00

(52) U.S. Cl. 455/550.1

(57) ABSTRACT

A context efficient keyboard entry method uses default keypad maps based on statistical information and the context of the currently entered message in order to improve character entry efficiency. In one embodiment of the invention, different keypad maps are used for the first letter, second letter and Rest Of Word (ROW). In another embodiment, the characters assigned to each keypad key are arranged based on alpha character profile usage while alphabetical order is maintained. In still another embodiment, dynamic keypad labeling is used to change from two key entry modes such as numeric mode or alpha (or alpha numeric) modes, or between a dialing mode and a text entry mode.

### TECHNICAL FIELD

This invention relates in general to the field of electronics and more specifically, to a method and apparatus for providing efficient text entry using a keypad.

### BACKGROUND

The current methods of entering text using a keypad in an electronic device such as a wireless communication device (e.g., cellular telephone, etc.) is very slow and time consuming. The standard wireless communication device uses only twelve keys and sometimes a few more “special function” keys to enter text messages. In FIGS. 1 and 2, prior art keypads that are used in wireless communication devices are shown.

In a typical text entry routine, a user has to depress the same key multiple times until the desired letter appears in the communication device's display. In order to cover all the alphanumeric letters, three or four letters are assigned to each number key as shown in the keypads of FIGS. 1 and 2. Each key must be pressed one or more times until the desired letter appears on the display. For example, to select the alpha character “B”, the number “2” key as shown in FIG. 1 must be pressed once to select the letter “A” then a second time to reach the letter “B”, while if the desired letter was the letter “C,” the number “2” key must be pressed three times. For the number “2” key as an example, the system cycles through the fixed sequence of letters: A-B-C-2-A-B-C, etc. In addition, in order to provide a communication device user the capability to select two consecutive letters that are assigned to the same key (e.g., the letters A and B), a timer will start when a key is pressed. If the same key is pressed before the timer expires, the next letter in the sequence of that key will replace the current letter. If the timer already expired, a new letter will be entered once the key is pressed again. In other words, if the key is not pressed (activated) in 1.5 seconds as an example, the displayed character is automatically accepted and the cursor moves to the next text entry position in the display.

As described above, the current method of typing text using the standard keyboard techniques currently in use in electronic devices such as wireless communication devices is both time consuming and tedious, especially when lengthy text messages need to be sent. A need thus exists in the art for a method and apparatus for providing efficient text entry using a keypad.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIGS. 1 and 2 show prior art keypads that are used in electronic devices for text entry.

FIG. 3 shows a communication device in accordance with an embodiment of the invention.

FIG. 4 shows how probabilities of occurrence are collected in accordance with an embodiment of the invention.

FIG. 5 shows a table for codes for a three letter key in accordance with an embodiment of the invention.

FIG. 6 shows a table for codes for a four letter key in accordance with an embodiment of the invention.

FIG. 7 shows a flowchart highlighting the overall process for providing efficient text entry in accordance with an embodiment of the invention.

FIG. 8 shows a data model of a context sensitive keypad in accordance with an embodiment of the invention.

FIG. 9 shows a flowchart for a key press handler routing in accordance with an embodiment of the invention.

FIG. 10 is a table showing a prior art alpha character usage profile.

FIG. 11 shows a bar graph of the usage profile shown in FIG. 10.

FIG. 12 shows a keypad in accordance with an embodiment of the invention.

FIG. 13 shows a bar graph highlighting the key groupings of the keypad shown in FIG. 12.

FIG. 14 shows a keypad in accordance with an embodiment of the invention.

FIG. 15 shows a bar graph highlighting the key groupings of the keypad shown in FIG. 14.

FIG. 16 shows a keypad in accordance with an embodiment of the invention.

FIG. 17 shows a bar graph highlighting the key groupings of the keypad shown in FIG. 16.

FIG. 18 shows a keypad in accordance with an embodiment of the invention.

FIG. 19 shows a bar graph highlighting the key groupings of the keypad shown in FIG. 18.

FIG. 20 shows a keypad in accordance with an embodiment of the invention.

FIG. 21 shows a bar graph highlighting the key groupings of the keypad shown in FIG. 20.

FIGS. 22-24 highlights an embodiment of the invention where the keypad labeling can change dynamically between a numeric mode and an alpha and/or alphanumeric mode.

FIGS. 25-27 highlight another embodiment of the invention where the keypad labeling can change dynamically between a dialing mode and a text entry mode of operation.

FIG. 28 shows a block diagram of a radio communication device in accordance with the invention.

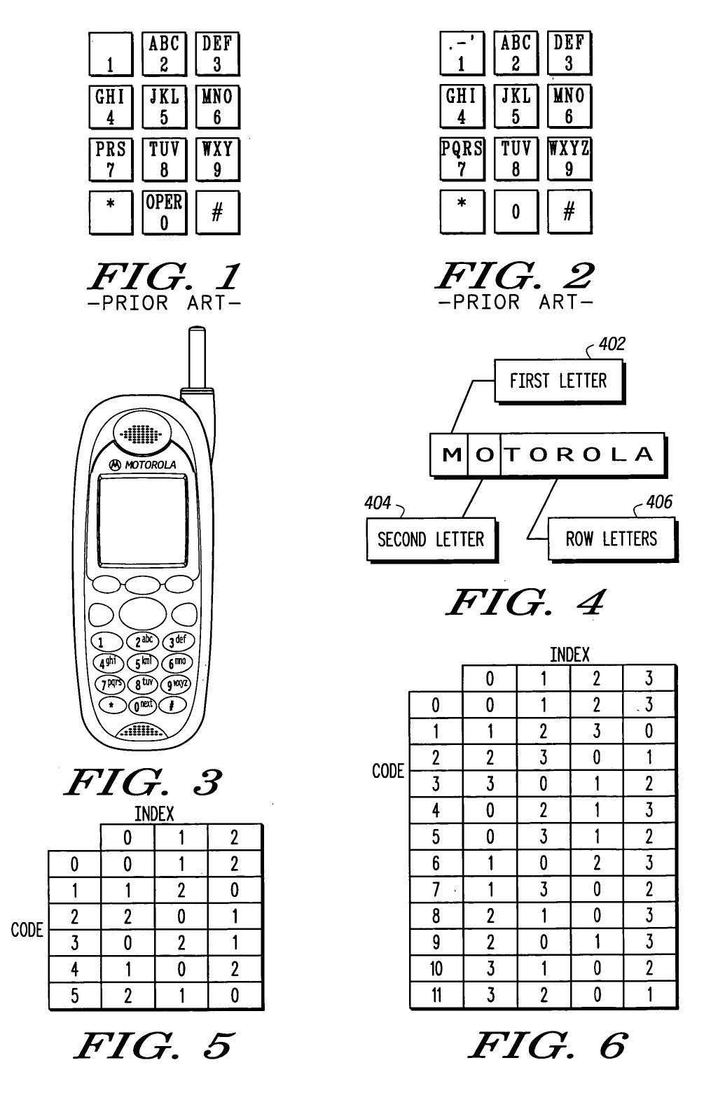

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

It is possible to calculate the probability of occurrences of each letter from a large sample of emails, Short Message Service (SMS) messages, etc. using an offline program. In accordance with an embodiment of the invention, the statistical information collected is used to change the letter sequence of the pressed key in accordance with the context of the currently displayed text. The first step in the overall process involves collecting the statistical information and to generate default key maps. For each word of the sampled emails, etc. the probability of occurrence of its letters is collected for three different contexts: the first letter of the word 402 as shown in FIG. 4; the second letter 404 of the word; and the Rest Of the Word (ROW) 406.

The second step in the process is to generate the map for the keypad based on the gathered statistical information. The letter sequences are encoded using the coding tables shown in FIG. 5 for three letter keys and the coding table shown in FIG. 6 for four letter keys used in the keypad. The index refers to the letters in each key of the keypad. The code in each table refers to the particular letter sequence a particular key will have assigned to it. By using the tables, it simplifies the algorithm for selecting letter sequences for each key in the keypad since the algorithm simply has to use a code number (0-5 for a 3 letter key as shown in FIG. 5, or 0-11 for a 4 letter key as shown in FIG. 6) to know what particular letter sequence will be assigned to a particular key. The use of tables, helps simplify the overall software algorithm.

As an illustrative example, taking the number 2 key shown in FIG. 1 (a 3 letter key), code 0 (default sequence) would have the index sequence of 0, 1 and 2. Index 0 representing the letter A, index 1 represents the letter B and index 2 representing the letter C. If code 2 in the table is selected, the letter sequence would then be changed to C, A then B when a user presses the number 2 key during alphanumeric entry, since code 2 has a sequence of 2, 0 and 1. Each key in the keypad would have either a 3 letter table or a 4 letter table (e.g., numbers 7 and 9 in the keypad shown in FIG. 2) assigned to it.

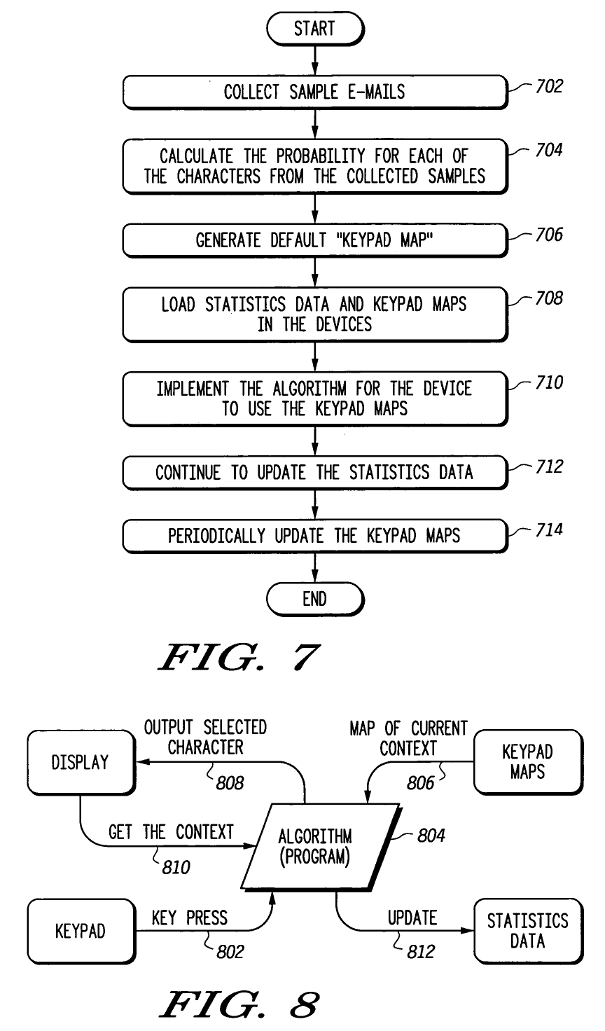

In FIG. 7 there is shown a flowchart highlighting the overall process steps taken in accordance with an embodiment of the invention. In step 702, sample text such as emails is collected. This information can be collected using sample text messages, emails, etc. In step 704, the probability for each of the characters from the collected samples is calculated. The default “keypad map” is generated in step 706.

In step 708, statistics data and keypad maps are loaded into the electronic device. In step 710, the algorithm for the device to use the keypad maps is implemented. In step 712, the statistical data is continually updated. Finally, in step 714, the keypad maps are periodically updated. It should be noted that statistical data and keypad maps may be continually updated (steps 712 and 714) concurrently with other steps shown in FIG. 7.

For the first letter scenario, one key map is generated. This map specifies the letter sequence for the number keys when the user enters the first letter of a word. For the second letter scenario, the key map used is based on the statistical information that has been gathered of a “First Letter” followed by a “Second Letter”. For each first letter, a key map is generated. There are a total of 26 key maps for this scenario. For example, if the first letter entered is an “A:, the “A-maps” will be used to specify the letter sequences for each number key that will be used to enter the second letter in the text string. As such, using the present invention, the most statistically likely letters to be selected after the letter “A” will be placed first in the letter sequence for each key in the keypad.

For the ROW scenario, the key map is based on the statistical information of a certain “ROW letter” followed by another “ROW letter”. One key map will be generated for each letter and total up to 26 key maps. For example, if the letter at the cursor is “E” then the E-map will be used to specify the letter sequences for number keys to enter the next letter. Each key will be linked to a particular code from a three or four letter table (see FIGS. 5 and 6). In one embodiment of the invention, each of the number keys will present the most statistically likely letter to be used after the letter “E”. For example, for the number seven key, the first letter in the selection sequence may be changed to “R” instead of the letter “P”.

Once the default maps are generated, the next step is to implement the algorithm to use those key maps for text entry. The data model of the context sensitive keypad system is shown in FIG. 8. The main program 804 takes the pressed key 802 as an input, reads the message context 810 from the display, loads the corresponding keypad map 806, and finally outputs 808 the selected letter to display. It may also optionally update the local statistical information database 812.

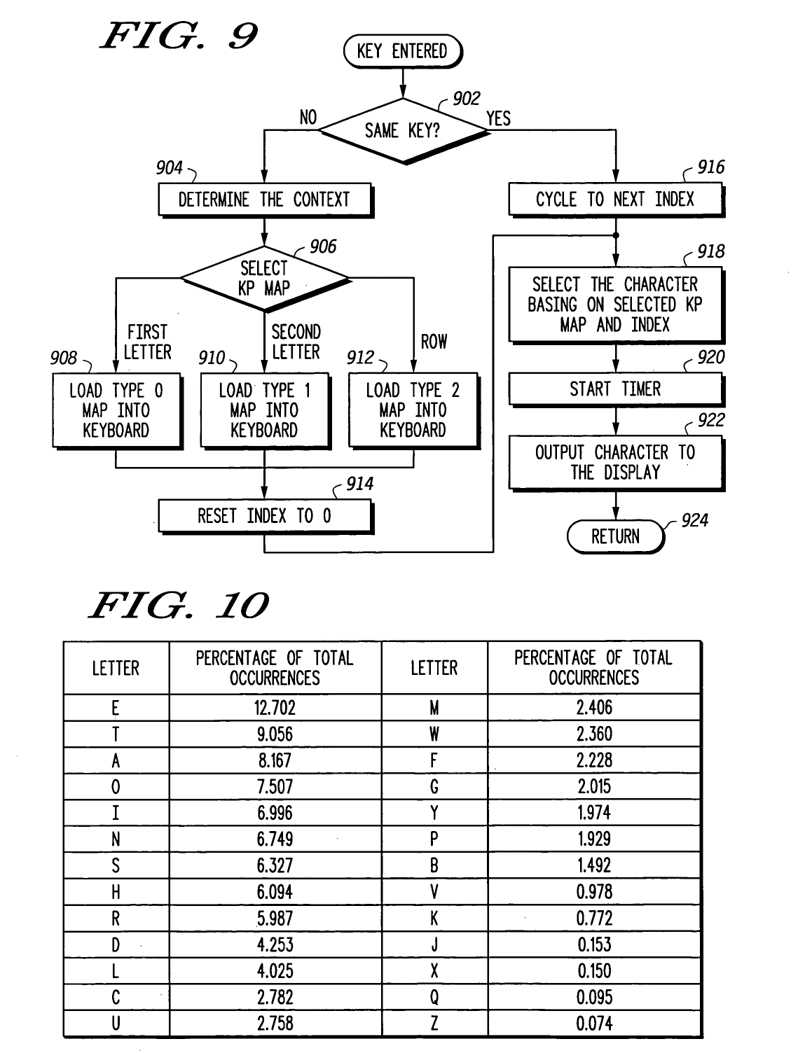

Referring now to FIG. 9, there is shown a flow chart that describes the algorithm used to handle an input key. Its main task is to determine the key code and cycle index. Then it uses this information to extract the fixed sequence index from the 3-letter table shown in FIG. 5 or the 4-letter table shown in FIG. 6 depending on whether the pressed key is a 3-letter or 4-letter key. The selected letter is then derived from the fixed sequence index. For example, the fixed sequence index (letter sequence index or simply index) of “A” is 0, for “B’ it is 1, etc.

In step 902, it is determined if the same key has been pressed. If it is not the same key, in step 904 the context is determined. In this embodiment, the context determination step will determine if the first letter, second letter or ROW of a word is currently being entered. In step 906, the key map is selected depending on whether it is for the first letter, the second letter or the ROW. If the selected keypad map (also referred to as KP map or simply key map) in step 906 is for the first letter, in step 908, the type “0” map is loaded and used for keypad entry. If the selected key map in step 906 is for the second letter, the type “1” map is loaded for use by the text entry routine. While if in step 906 the key map loaded is for the ROW, the type 2 map is loaded. The type of maps refer to the maps that have been generated based on statistical data for either a single letter (first letter) a second letter in a word that has a particular first letter, etc. It should be noted that the present invention can be designed using different mapping sequences depending on the amount of memory available to the designer, etc. For example, in another embodiment, only the previous letter entered may be used to select key maps for each key for the next key entry. As previously mentioned, once a key map is selected for a key, a particular code will be assigned to the key in order to simplify the overall letter selection routine.

In a further optional embodiment of the present invention, if an electronic device supports multiple languages such as English, Spanish, etc., the contexts of the implemented languages can also be annotated in the form of keypad maps, so the context of the message being received can not only include first letter, second letter, etc., but also different languages.

In step 914, the index (used in tables of FIGS. 5 and 6) is reset which causes the letter sequence for each key in the keypad to go back to code 0 or its default sequence (e.g., A, B and C for key number 2). In step 918, the text character is selected based on the selected key map and index. In step 920, a timer is started that allows the user a predetermined period of time to select a character before the highlighted character currently on the display is automatically selected. This step is similar to that used in the prior art and is used to allow for the selection of another letter of a word that is assigned to the same key in the keypad as the previous letter in the word. In step 922, the character selected is displayed, and the routine returns to the start in step 924.

If in step 902, it is determined, that the user has pressed the same key again, in step 916, the current index in the letter sequence assigned to the key is moved to the next index (letter) in the sequence prior to performing step 918, since the user is attempting to find another letter in the letter sequence assigned to that particular key.

If the key entered is the same key as determined in step 902, in step 916, the routine cycles to the next index (letter) in the letter sequence. As an illustrative example of the routine in FIG. 9, if a user was going to type the word “HOME” using the keypad shown in FIG. 2, the routine would begin by receiving the first key press (e.g., key number 4 in this example), and determining if it is for the first letter in a word. Once the routine has determined that the key press is for the first letter, key maps are assigned to each key with a particular code being assigned to each key as previously discussed. The code of course signifying what particular letter sequence will be used for each key when the user depresses the key.

In this particular example, since it is the first key in the word, the default map for key number 4 is used, which would have the letters in their standard order G, H, and I. In another embodiment of the present invention, a different letter sequence may be assigned to the number 4 key. Upon the first key press, the letter “G” would be shown on the screen, in this example, since the word HOME is to be entered, the user presses the number 4 key again, and the routine cycles to the next letter in the sequence which is the correct letter “H”. The user then presses the next key, key number 6. The routine then determines that the context is that of a second letter in a word and the routine selects the appropriate key maps to use (type 1 or second letter maps). The letter index for each sequence of letter is set to zero or the default sequence for these particular maps.

It may very well be that the key map assigned to the number 6 key may have a default letter sequence that starts with the letter “0” since the first letter in the word “HOME” is a consonant. In which case, the letter “0” would appear on the display, cutting the number of key presses the user would have had to press the number 6 key as compared to the prior art. In the prior art, were the letter sequence for each key stays fixed throughout, the letter “O” would be the third letter assigned to the number 6 key requiring three key presses to reach.

Once the letters “HO” have been entered, the user would then press the letter 6 key after the timer in step 920 would have expired since the user knows he needs to enter a new letter in the word and the same key number has to be pressed. Since the word is now in its third letter, in this embodiment of the invention, the type 2 maps or ROW maps are used and assigned for each key in the keypad. Depending on the design, statistical analysis could have that the letter sequence assigned to the number 6 key should be the default sequence of M, N and O, since a consonant is more likely to follow the letter “O” than a vowel. In this case, the user upon pressing the number 6 key would have shown on the display “HOM”.

Finally, the user would press the number 3 key. Again, the routine would pick type 2 or ROW maps for each key, since we are in the ROW of the word. In this case, the letter sequence assigned to the number 3 key could be E, F and D, since it is probably more likely for a vowel to follow the letter “M”. Using the context sensitive selection process of the present invention would reduce the number of key strokes as compared to the prior art approach by another key stroke. As such, once the user presses the number 3 key, the word “HOME” is displayed on the screen. As shown, the present invention would have saved approximately three key presses in entering the word “HOME” as compared to the fixed letter sequence technique used in the prior art. This of course reduces the time it takes a user to enter a text message and simplifies overall text entry.

The use of the context sensitive key choices as discussed above reduces the number of required key strokes by about approximately 30-40% compared to the prior art method. The context sensitive technique is also easy to implement and provides a similar look and feel to the conventional tap method. By moving the sequence of the alpha characters for each key based on the current text (context) that is being entered provides for more efficient text entry and reduces user frustration and fatigue.

In another embodiment of the present invention, since some communication devices do not assign alpha characters to the 1 or 0 keys and sometimes even the “*” and “#” keys as shown for example in the keypad of FIG. 1, alpha characters are assigned based on the alpha character profile usage to optimize character entry efficiency, or by using numeric and alphanumeric dialing/text entry modes.

By taking advantage of up to all 12 keys on a standard numeric telephone keypad, and in particular, remapping the alpha character assignments such that high-usage alpha characters are assigned as the first character of potentially multiple characters assigned to a single key, entering text into an electronic device such as a cellular telephone is made easier and more efficient.

In FIG. 10, there is shown a conventional frequency of occurrence of single letters as found in table 1 of U.S. Pat. No. 6,348,878, entitled “Data Entry Keyboard” by Kenzo Tsubai. A study conducted by one of the inventors using over 100 short email messages as a sample base, having an accumulated character total of almost 5000 characters, showed remarkable similarity to the Becker/Piper results shown in FIG. 10 with a standard deviation of less than 0.5%. Based on these findings, the inventors assume for this discussion that the character profile is consistent and that a special two-way text messaging profile is not necessary for character key assignment optimization for a communication device (although the same statistical collection as done in the first embodiment of the invention previously discussed can also be utilized).

Reassigning alpha characters to keypad keys can be easily analyzed using a bar graph of the Becker/Piper profile as shown in FIG. 11. Ideally, any of the alpha characters that are above the horizontal line (>5% frequency of occurrence) should be the first alpha character on its own keypad key. This would improve text entry speeds for two reasons: each of the keys would require only one key press to select; and these common alpha characters would be placed on separate keys of the keypad, which may reduce the text entry scenario where two alpha characters that need to be entered happen to be on the same key, which slows down the entry of characters.

Since the user experience would require that the keypad alpha character assignments remain in some form of common format, alphabetical for example (QWERTY would be another option), the situation is complicated because of the groupings of high usage characters, mainly (H,I), (N,O) and (R,S) in the standard telephone keypads used in cellular telephones. Two options to resolve this problem while maintaining alphabetical order are:

(a). Assign only one alpha character to some keys, however the limitation to this is that the number of available keys in a communication device is limited; or

(b). Assign two or more of the high frequency of use alpha characters to the same keypad key and not achieve maximum optimization.

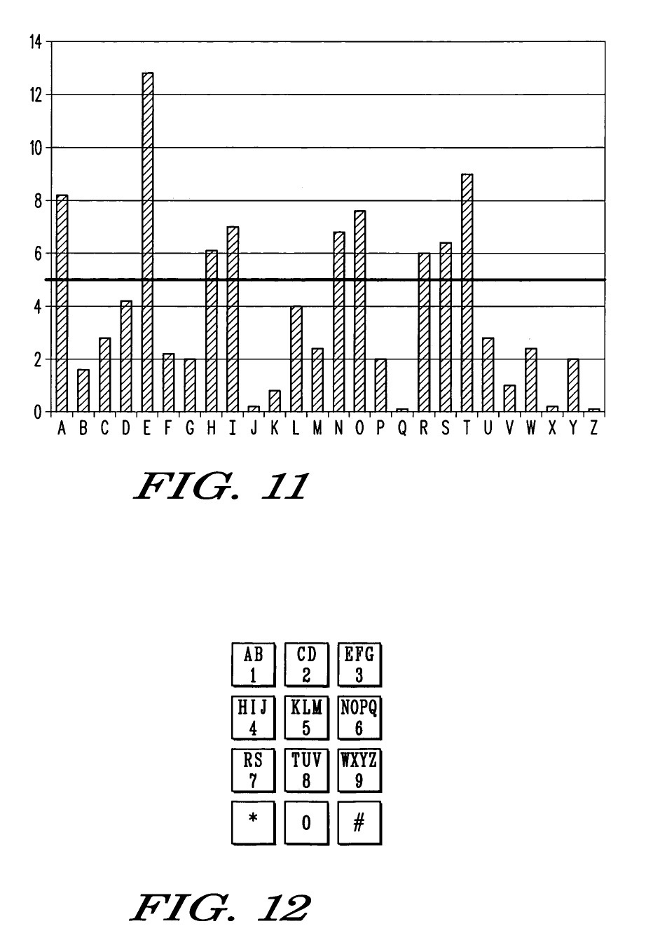

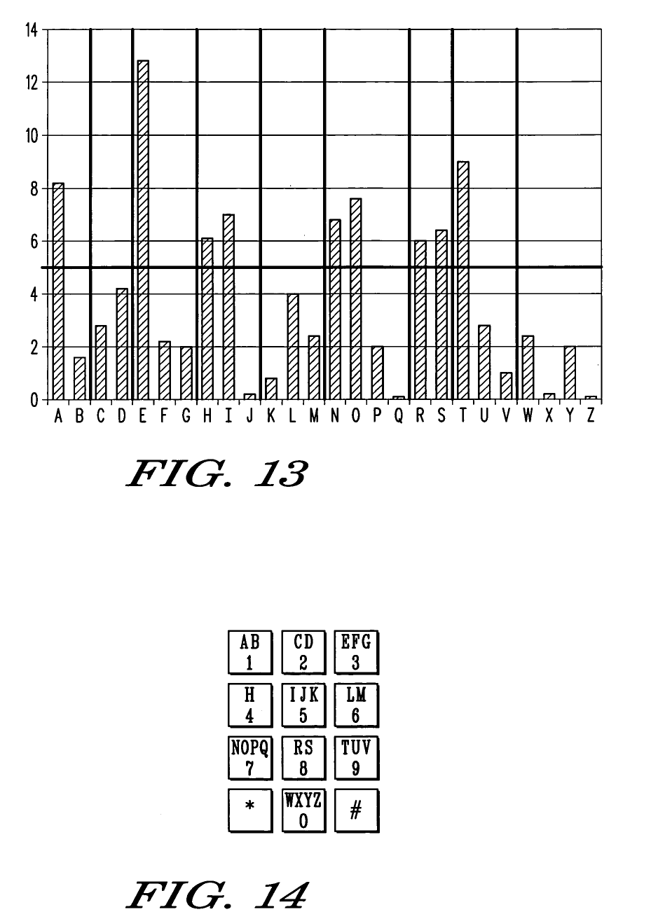

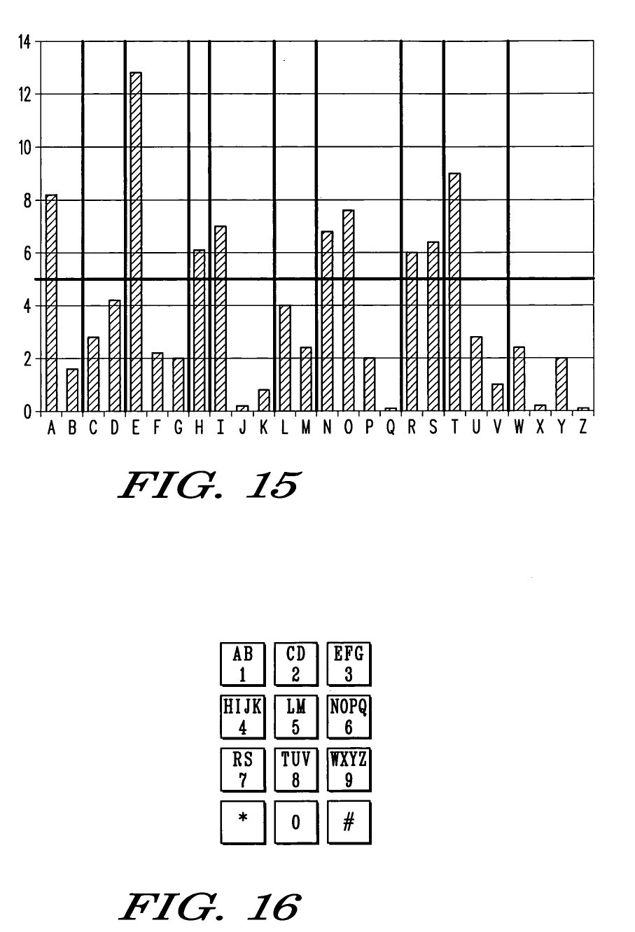

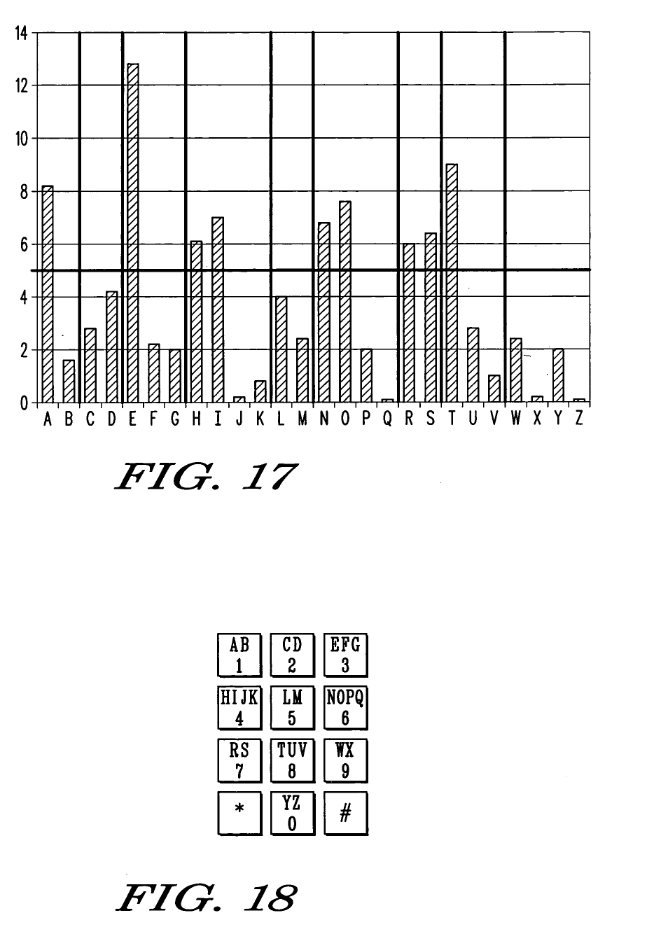

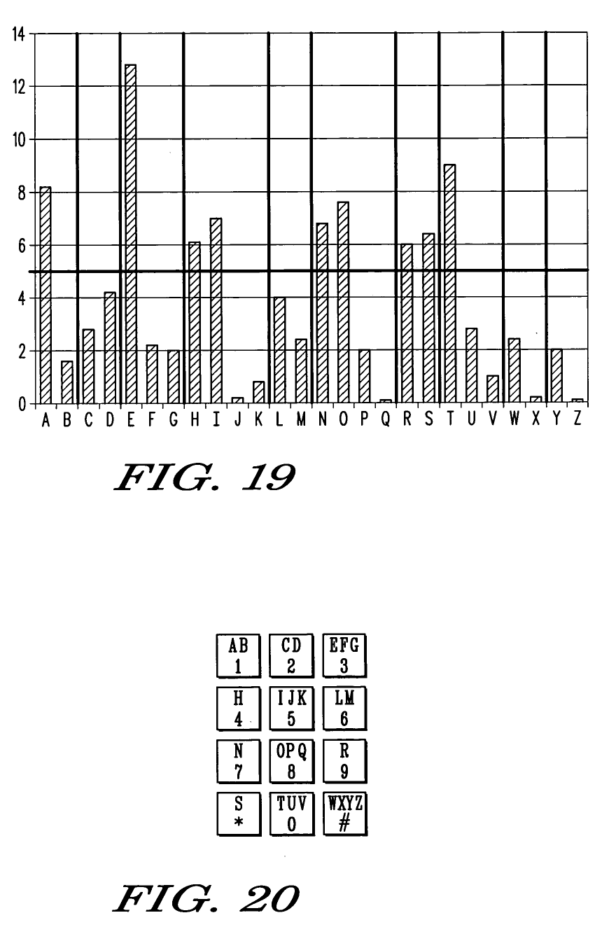

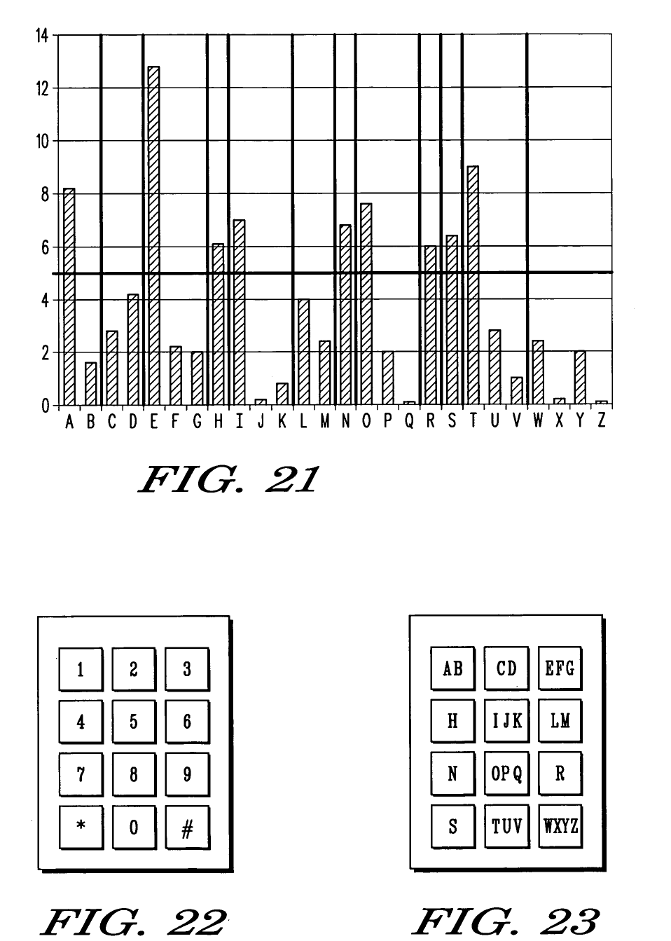

Five potential keypad organization scenarios in accordance with the invention are shown in FIGS. 12, 14, 16, 18 and 20, with their corresponding frequency tables shown in FIGS. 13, 15, 17, 19 and 21 respectively. The character placement shown in the keypad of FIG. 20 is the preferred placement of characters in the keypad given its improved text entry efficiency.

In a probability study conducted using a 100 character text message that included 22 spaces (assuming an average word length of 4.5 characters), and that assumed: (1) the key press of a new character takes 0.5 seconds, (2) alpha characters that require additional key presses to cycle to the next character take an additional 0.33 seconds per additional key press, and (3) when the next alpha character uses the same key as the previous character, there is an additional 0.5 second wait, the estimated text message entry time for the different keypad configurations shown in FIGS. 12, 14, 16, 18 and 20 and a standard keypad such as that shown in FIG. 1 were as follows:

| KEYPAD | # KEY | | % REDUCTION |
|---|---|---|---|
| (shown in) | PRESSES | ENTRY TIME | (over standard Keypad) |
| Standard (FIG. 1) | 238 | 104 seconds | |
| | 176 | 83 seconds | 20% |
| | 165 | 78 seconds | 25% |
| | 173 | 81 seconds | 22% |
| | 169 | 80 seconds | 23% |
| | 149 | 72 seconds | 31% |

The entry times shown above, especially for the keypad of FIG. 20 show a very good improvement in entry times as compared to a standard keypad. Even when compared to an “ideal keypad” having one alpha character per key (e.g., a QWERTY-based pager, etc.) which would use 122 key presses and take approximately 61 seconds to enter the same text message, the present invention keypad having only a limited number of keys, as compared to the “ideal keypad”, performs quite well.

The inherent issue with changing the alpha character assignments for the telephone standard assignments is that telephone numbers with text in them (e.g., 1-800-ABCDEF9) can no longer use this direct approach. Losing such a capability may not be much of a loss since text-based phone numbers are not very common, and businesses will usually accompany the text-based phone number with the full numeric phone number. However, a user could accidentally enter a text-based phone number using a phone with a reassigned alpha character keypad, which would result in the user entering an incorrect phone number.

There are several potential solutions to the above problem, with one of them being that the user cannot use text-based numbers for dialing, or that the user must enter the number as a text entry. A text entry mode allows the user to enter a phone number mixed with text, so a phone number such as 1-800-ABCDEF9 would be entered so that it would look like “1800ABCDEF9” on the user's display, and not 18002223339. In either case, the user needs to be aware that the alpha character assignments cannot be taken directly since they do not match the standard telephone keypad assignments. Entering a text-message phone number must be entered in text entry mode, not numeric mode.

Other more “user friendly” methods, although more expensive, would be to have a keypad in which the keypad labeling is changed dynamically, using for example electronic ink technology that changes characters electronically or having the keys be shown in a large touch screen display that allows for dynamic changing of the key labels between two modes. In one embodiment the communication device text entry software is in one of two key entry modes, numeric text entry mode or alphanumeric text entry mode. The user can switch between the two entry modes at any time, whether in a dialing mode or in a text entry mode, such as when writing a two-way text message. When dialing a phone number that has some text in it as an example, the user merely switches to the alphanumeric mode when it comes time to enter the alpha characters. For example, if the user is to enter the phone number “1-800-ABCDEF9”, the user would enter “1800” in the numeric mode, switch to the alpha mode, and enter “ABCDEF”, and switch back to the numeric mode and enter “9”. The display would show “1800ABCDEF9” as the entered phone # (not 18002223339). The software would know to correctly map the text “ABCDEF” to “222333” because it is in the dialing mode.

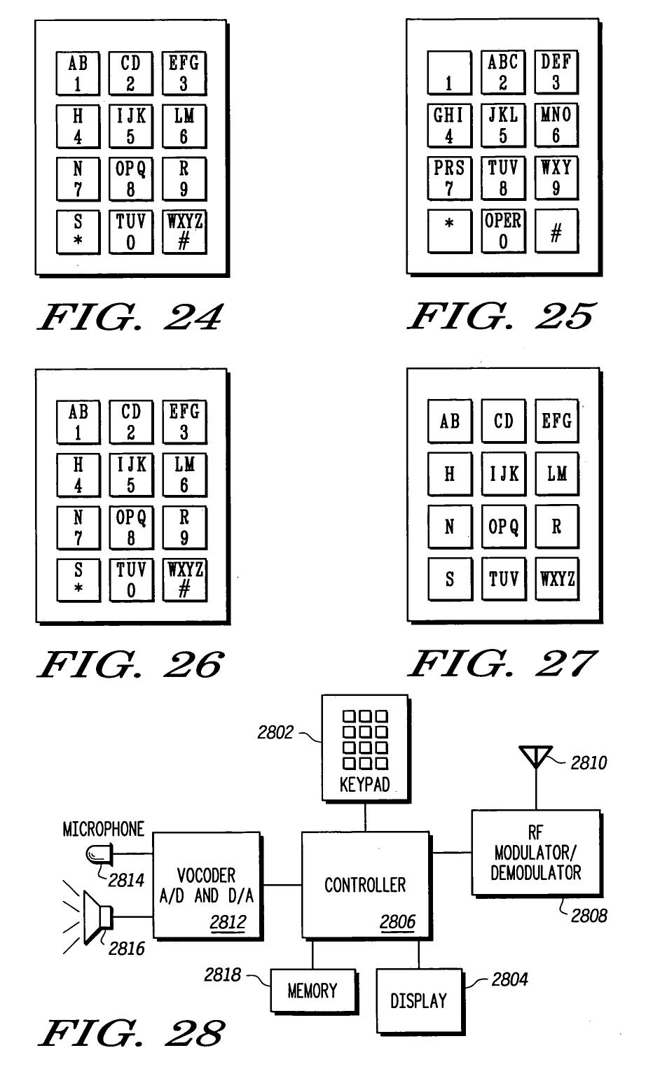

In FIG. 22, the numeric mode keypad labeling for the above embodiment is shown, while in FIG. 23 the alpha mode keypad labeling is shown. Optionally, instead of the alpha mode labeling as in FIG. 23, an alphanumeric labeling as shown in FIG. 24 can be used, although not as efficient as toggling between numeric and alpha modes.

In a second embodiment of the dynamic keypad labeling technique, the communication device software can always be in one of two operating modes; a dialing mode in which the keypad resembles a standard telephone keypad as shown in FIG. 25, and a text entry mode in which the keypad labeling changes to an optimized alphanumeric keypad assignment as shown in FIG. 26 or alpha only key assignment as shown in FIG. 27.

Referring now to FIG. 28, there is shown a block diagram of a communication device such as a wireless communication device in accordance with the invention. The wireless communication device includes a controller 2806 such as a microprocessor and/or digital signal processor that controls the overall function and operation of the communication device. A keypad 2802 and display 2804 are coupled to the controller 2806 and allow for user interface with the communication device. Keypad 2802 can take the form of any of the keypads discussed above in accordance with the different embodiments of the invention. Controller 2806 provides all of the necessary control of keypad 2802 in accordance with the different efficient text entry techniques previously discussed. Memory 2818 can store all of the necessary keypad maps required in some of the previously discussed efficient text entry embodiments.

A microphone 2814 is provided for converting voice from the user into electrical signals, while a speaker 2816 provides audio signals to the user. A vocoder, Analog-to-Digital (A/D) and Digital-to-Analog (D/A) block 2812 provides all the necessary digital voice processing for converting analog voice into digital data ready for RF transmission and vice versa. RF modulator/demodulator (transmitter/receiver) block 2808 transmits and receives the RF signals via antenna 2810. A memory 2818 such as Random Access Memory (RAM) and/or Read Only Memory (ROM) coupled to controller 2806 stores the necessary instructions and information for controller 2806.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for providing efficient character entry in an electronic device including a keypad having a plurality of keys, comprising the steps of:
determining a context of a message being entered; and
changing a character sequence assigned to at least one of the plurality of keys based on the context of the message.

2. A method as defined in claim 1, further comprising the steps of:
selecting a keypad map based on the context of the message and using the keypad map to determine the character sequence assigned to each of the plurality of keys.

3. A method as defined in claim 2, wherein the keypad map selected is dependent on whether one of a first letter, second letter and Rest Of The Word (ROW) in a word is currently being entered.

4. A method as defined in claim 3, wherein the character sequence assigned to each of the plurality of keys is automatically changed based on a current context of the message being entered into the electronic device.

5. A method as defined in claim 3, wherein the keypad map selected is dependent on a language being used.

6. A method as defined in claim 2, wherein a plurality of keypad maps are stored in the electronic device.

7. The method of claim 6, wherein the plurality of keypad maps stored in the electronic device are periodically updated based on statistical data gathered regarding the characters being entered.

8. An electronic device, comprising:
a keypad having a plurality of keys;
a controller coupled to the keypad; and
a memory coupled to the controller, the memory having stored therein a plurality of keypad maps that are used to control the character sequence assigned to each of the plurality of keys.

9. An electronic device as defined in claim 8, wherein the controller selects which of the keypad maps stored in memory to use.

10. An electronic device as defined in claim 8, wherein the controller determines which keypad map to select based on a context of a message being entered via the keypad.

11. An electronic device as defined in claim 10, wherein the keypad map used depends on whether one of a first letter, second letter and Rest of the Word (ROW) of a word is currently being entered via the keypad.

12. An electronic device, comprising:
a keypad having a plurality of keys; and
assigning alpha characters to at least some of the plurality of keys based on an alpha character profile while maintaining alphabetical order.

13. An electronic device as defined in claim 12, wherein the alpha characters having the highest usage based on the alpha character profile are assigned as the first character in at least some of the plurality of keys.

14. An electronic device as defined in 13, wherein the alpha character profile used to determine the alpha character order for the at least some of the plurality of keys is based on the frequency of use of each character.

15. An electronic device as defined in 14, wherein the electronic device comprises a wireless communication device.

16. An electronic device, comprising:
a keypad including a plurality of keys having dynamic keypad labeling;
a controller coupled to the keypad; and
the controller dynamically changes the characters assigned to the plurality of keys depending if the electronic device is in either a first or second operating mode.

17. An electronic device as defined in claim 16, wherein the first operating mode comprises a numeric mode in which some of the plurality of keys are dynamically assigned and labeled with a numeric number.

18. An electronic device as defined in claim 17, wherein the second operating mode comprises either an alpha mode in which the plurality of keys are dynamically assigned and labeled with an alpha character or an alphanumeric mode in which some of the plurality of keys are dynamically assigned and labeled with numeric and alpha characters.

19. An electronic device as defined in claim 16, wherein the first operating mode comprises a dialing mode and the second mode comprise a text entry mode.

20. An electronic device as defined in claim 19, wherein in the dialing mode the plurality of keys are dynamically assigned and labeled in a standard telephone keypad format.
